(19) United States
(12) Patent Application Publication
(10) Pub. No.: US 2018/0000172 A1
(43) Pub. Date: Jan. 4, 2018

(54) GARMENT CONTAINING INSECT REPELLENT DEVICE

(71) Applicant: Thermacell Repellents, Inc., Bedford, MA (US)

(72) Inventors: Stephen S. Hill, Bedford, MA (US); Stephen J Shapiro, Bedford, MA (US)

(21) Appl. No.: 15/540,286

(22) PCT Filed: Dec. 28, 2015
(86) PCT No.: PCT/US15/67588

§ 371 Date: Jun. 28, 2017

Related U.S. Application Data
(60) Provisional application No. 62/098,397, filed on Dec. 31, 2014.

(51) Int. Cl. A41D 13/00; A41B 1/08; A01N 25/34; A41D 1/06; A41F 1/00; A41D 27/20

(52) U.S. Cl. CPC A41D 13/001; A41F 1/002; A41D 27/201; A01N 25/34; A41D 1/06; A41B 1/08; A41D 2300/326

(57) ABSTRACT

A garment having added exterior pockets in which low temperature volatizable insect repellent mats may be carried which disperse the volatizable chemical at ambient temperature or in which an additional exothermic mat is provided to assist in the dispersion of the chemical.

### RELATED APPLICATION

This application is based on and claims the priority of U.S. Provisional Patent Application Ser. No. 62/098,397, filed Dec. 31, 2014, the invention and contents of which are incorporated herein.

### BACKGROUND OF THE INVENTION

This invention relates to a new and novel garment which has pockets to hold wearable insect repellent devices suitable for personal use in outdoor environments.

Hunters, fisherman and others who like to explore the outdoors often encounter unpleasant insect attacks.

The concept of a wearable insect repellent garment is in the prior art, and U.S. Pat. No. 7,168,630 teaches such an apparatus. That patent describes various approaches to a wearable device, including clip-on and the like, and requires a blowing means to disperse the insecticide. Powering a blowing means is undesirable from a physical size consideration and may cause a slight amount of noise, all of which is undesirable in many outdoor environments. Clip-on devices may be knocked off the user as they walk past brush, branches or any projecting object.

### SUMMARY OF THE INVENTION

The present invention is directed to new and novel wearable outdoor insect repelling systems in which pockets are sewn in or attached to garments in which a low temperature volatilizable chemical such as metofluthrin and/or transfluthrin carried on a mat is placed. By employing a sufficient exothermic reaction in the mat or pad carrying the low temperature chemical, sufficient heat is generated to both vaporize the chemical and cause it to be dispersed and spread from the apparatus carrying the device. Additionally, since the exothermic reaction operates at relatively low temperature with low temperature active ingredients, thermal safety is more easily achieved. Further additional pads having exothermic properties can be added to the pocket to further heat the pad. Under circumstances where the ambient temperature is warm no exothermic heat may be required to vaporize enough active ingredient to repel insects. The wearer's body heat may be employed to increase the speed of vaporization. A thermally conductive layer of woven metal or thermally conductive material may be placed on the side of the pocket towards the wearer's skin to help conduct body heat to the mat. An alternative is to just have a thin layer of plastic on the skin side of the pocket to allow for some heat transfer while keeping the insect repellent or active ingredient (AI) from touching the skin.

### BRIEF DESCRIPTION OF THE DRAWINGS

FIG. 1 is a front view showing locations for pockets for insect repellent mats carried either on the legs or arms of wearable clothing.

FIGS. 2A and 2B are plan views of a pocket or pouch added to a garment to hold the repellent device with a flap construction.

FIGS. 3A and 3B are cross-sectional views of the repellent device of this invention shown in FIGS. 2A and 2B.

FIG. 4 is a front plan view showing an impregnated mat with a handle portion enabling removal and insertion of an impregnated mat.

FIG. 5 is a cross-sectional view of the pocket of another embodiment of this invention attachable to clothing.

FIG. 6 is a front plan view of another embodiment of this invention.

### DETAILED DESCRIPTION

This invention takes advantage of lower temperature chemical insect repellents enabling volatilization at lower temperatures so as to provide relatively safe insect repellent mats capable of being worn without fear of the wearer accidentally touching hot surfaces.

Metofluthrin and transfluthrin are examples of chemicals which can be utilized with the present invention. These chemicals may disperse at ambient air so no additional heating may be required to cause dispersal in the mat of the present invention or can add an additional mat having an exothermic reaction to further heat the mat.

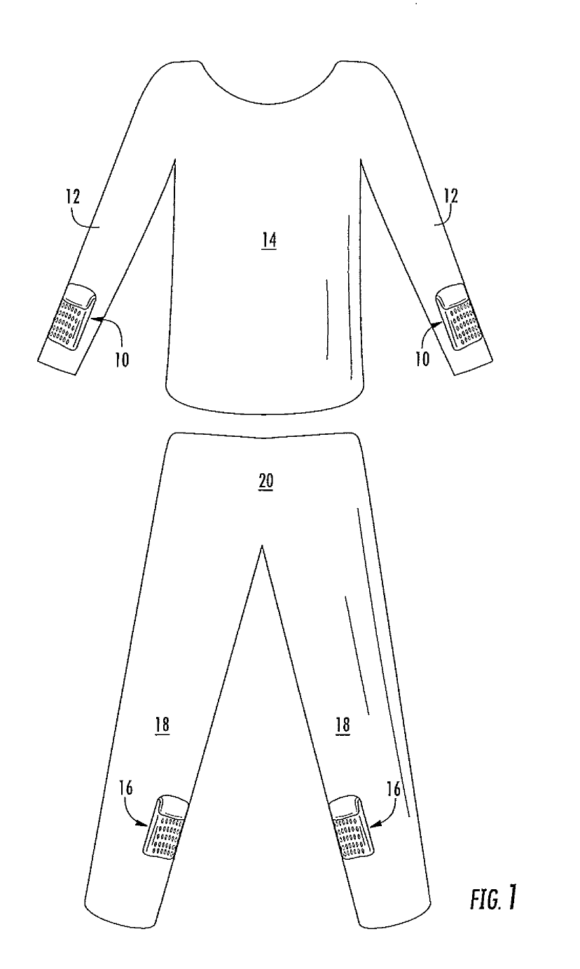

FIG. 1 is a front view of a shirt 14 and pants 20 with external patches or pockets 10 sewn in or physically attached to the lower portion of sleeves 12 of an apparel top 14. Pockets 16 are shown attached to or sewn into the lower portion of the legs 18 of pants 20. The present invention includes a mat 17 (see FIGS. 3A and 3B) sized to slip into the pockets 10 and 16 shown in FIG. 1. By providing the pockets at the locations shown, dispersion of the insect repellent material in mat 17 is achieved. In use, mat 17 is sealed in a plastic or other impermeable material, and when the seal is broken, ambient air reaches the impregnated mat thereby releasing insecticide flowing from the pockets in which the mats 17 are located. The mat when exposed to ambient air is placed in pocket 10 or 16.

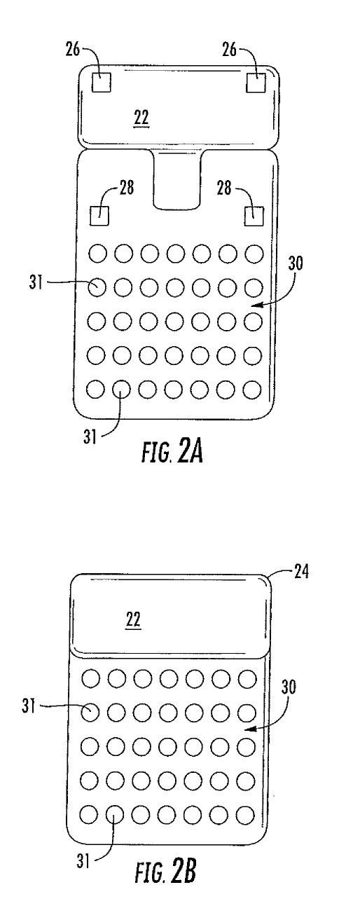

FIGS. 2A and 2B illustrate the pockets 10 and 16 for holding and dispensing a volatile substance. A flap 22 is foldable along the top edge 24 of the pouch, with closure means such as magnets 26 being attached to matching magnets 28 on the pouch itself.

The front portion of the pouch comprises a grill 30 which is formed in the outer face. The grill 30 prevents the user's fingers from touching the active surface of the mat. The grill can be formed of cloth with a series of eyelets or openings 31 laminated in a thin layer of cloth or cellular foam, and punching holes through the cloth and cellular foam. The grill layer 30 is formed as part of the added pocket or pouch 10 and 16.

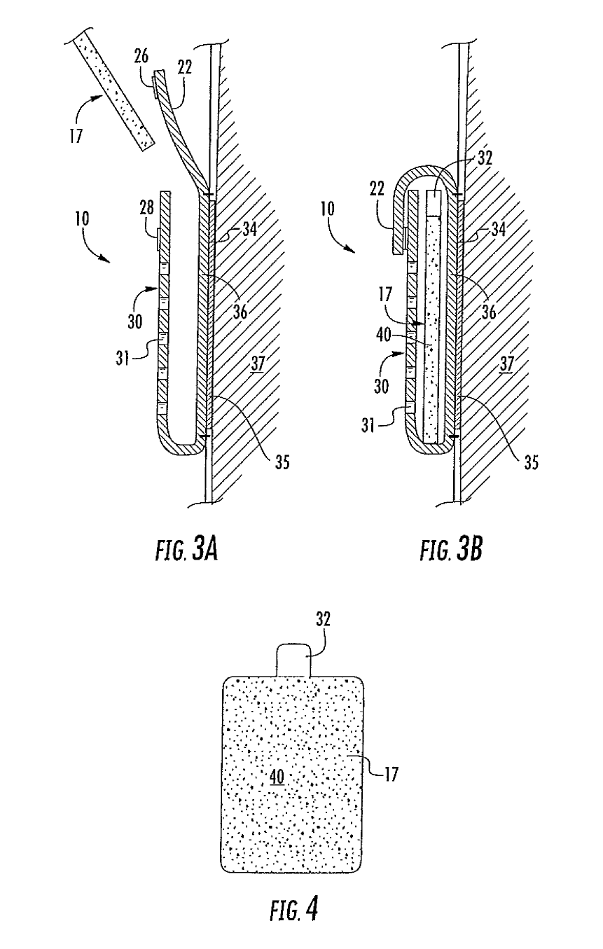

An impregnated mat 17 has a top portion or a projecting finger tab 32 (FIG. 4), which is free of insecticide or AI, so the mat 17 can be pulled out of the pocket area behind the grill and replaced as desired. Providing the finger tab 32 enables simple manual insertion and removal of the impregnated mat.

The flap 22 may be closed by the magnets shown in FIG. 2A or by Velcro, a snap or any other means, so that when the device is to be used, the mat 17 is taken from a sealed pouch, inserted with finger tab 32 (see FIG. 4) behind grill 30 and the upper portion 22 of the flap is closed thereby enabling the impregnated mat to be held within the pocket shown in FIGS. 2A and 2B.

FIGS. 3A and 3B are cross sectional views of the pocket 10 and 16 of FIGS. 1, 2A and 2B. The inside surface 34 of the pouch is vapor tight to prevent the active ingredients from penetrating to the wearer's skin. A layer of cloth/cell foam 36 is provided, but any type of material could be used to provide vapor proofing, preventing the chemical in the mat 17 from reaching the user's skin.

Referring to FIG. 3A, the mat 17 is inserted in the space between grill 30 and vapor tight layer 34, with the mat 17 being free of insect repellent at finger tab 32. The active area 40 of the mat 17 is shown in FIG. 4, and the handle or finger tab location 32 enables easy insertion and removal of the chemically impregnated mat 17.

A thin layer 35 of conducting material may also be placed on the garment 10 between person 37 and the pocket 10 to add body heat, as desired.

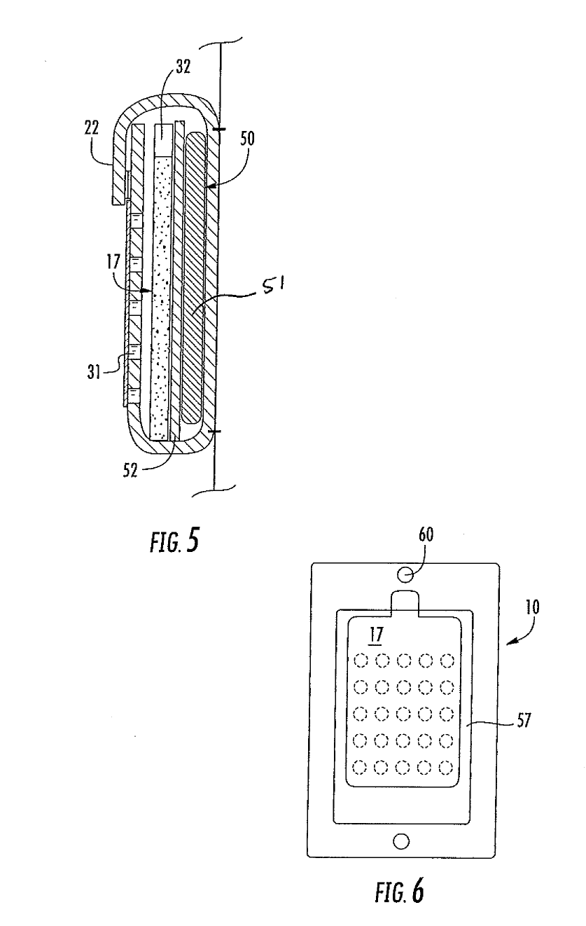

As shown in FIG. 5, the spacing between the grill 30 and the foam back layer 34 may be made sufficient to enable formation of a second pocket 50 behind the impregnated mat 17, the second pocket 50 is slightly larger than mat 17 and in which a second mat 52 impregnated with or formed of an exothermic material is inserted. A vapor proofing layer 51 may be provided behind exothermic mat 52. Mat 52 when open to the air generates sufficient heat to mat 17 to assist in the dispersal of insecticide impregnated in mat 17. Mat 52 may be formed of any of various materials having exothermic properties, such as for example, aluminum, silicon, boron or the like.

As described above, the mat 17 and exothermic mats 52 are maintained in vapor-tight packets so that no chemical is released until the packet is open.

FIG. 6 illustrates another embodiment to providing a wearable pocket 57 for insect repellent to be attached to clothing. Specifically, attachment points 60 could be snaps, buttons or the like attached to a matching connecting member located on the front of the clothing so as to easily attach the wearable pocket to the garment.

Instead of snaps or buttons, Velcro or the like could be used to attach a pre-assembled package including the mat 17, to the exterior of a garment as desired.

It should be understood that the preferred embodiment was described to provide the best illustration of the principles of the invention and its practical application to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly legally and equitably entitled.

1. A wearable insect repellent garment comprising:
a wearable garment having at least one external pocket with a partially exposed front,
said pocket comprising a grill on said partially exposed front, said grill being gas permeable permitting insect repellent to pass therethrough,
said insect repellent comprising chemicals volatilizable at low temperature permitting said chemicals to be volatized at ambient temperature, and
said insect repellent carried on a mat said mat sized to fit in said pocket.

2. A wearable insect repellent garment according to claim 1, wherein said garment comprises a sleeve, said pocket formed on said sleeve.

3. A wearable insect repellent garment according to claim 2, wherein said garment comprises legs, said pocket formed on at least one of said legs.

4. A wearable insect repellent garment according to claim 1, wherein said pocket comprises a top flap, said top flap closing said mat in said pocket.

5. A wearable insect repellent garment according to claim 4, wherein said flap is physically connected to said pocket to attach the flap to said pocket

6. A wearable insect repellent garment according to claim 5, wherein said flap and said pocket close by magnetic attraction.

7. A wearable insect repellent garment according to claim 5, wherein said flap and said pocket close by hook and eye attachments.

8. A wearable insect repellent garment according to claim 1, wherein said pocket is sewn onto said garment.

9. A wearable insect repellent garment according to claim 1, wherein said pocket is integrally formed as part of said garment.

10. A wearable insect repellent garment according to claim 1, wherein said grill prevents a wearer from physically touching said mat.

11. A wearable insect repellent garment according to claim 10, wherein said mat is carried in a sealed container, said sealed container being opened to permit removal of said mat therefrom and to allow said volatizable chemical to escape from said mat.

12. A wearable insect repellent garment according to claim 1, wherein said mat is impregnated with said volatizable chemical, said mat comprising a chemical free zone located at an edge thereof permitting manual handling of said mat without direct contact with said volatizable chemical.

13. A wearable insect repellent garment according to claim 1, wherein said pocket comprises a vapor barrier between said pocket and the skin of a wearer.

14. A wearable insect repellent garment according to claim 13, wherein said pocket comprises a thermally conductive material to conduct body heat to said mat.

15. A wearable insect repellent garment according to claim 1, further comprising an exothermic heater mat comprising exothermic chemicals, said exothermic heater mat being inserted in said pocket behind said mat carrying said insect repellent to enhance the dispersion of said volatilizable chemicals.

16. A wearable insect repellent garment according to claim 15, wherein said pocket comprises two adjoining vertical sections, one of said sections holding said mat carrying said insect repellent and the other holding said exothermic heater chemical.

17. A wearable insect repellent garment according to claim 1, wherein said garment comprises a plurality of pockets.
